(19) United States
(12) Patent Application Publication
(10) Pub. No.: US 2003/0023482 A1
(43) Pub. Date: Jan. 30, 2003

(54) Method and apparatus for redeeming of coupons via a wireless communication device

(76) Inventors: Amy E. Messner, Eugene, OR (US); William P. Brown, Corvallis, OR (US)

Correspondence Address: HEWLETT-PACKARD COMPANY, Intellectual Property Administration, P.O. Box 272400, Fort collins, CO, 80527-2400, US

(21) Appl. No.: 09/915,691

(22) Filed: Jul. 25, 2001

(51) Int. Cl. G06F 17/60; H04M 3/42

(52) U.S. Cl. 705/14; 705/17; 455/414

(57) ABSTRACT

A method and apparatus for wireless coupon redemption includes a coupon service provider coupled to a wide area network and a wireless network to deliver an electronic coupon to a transportable communication unit. A merchant, comprising a wireless receiver coupled to a redemption device, is coupled to the coupon service provider such that a tender of said coupon by the transportable communication unit made via the wireless receiver is conveyed to the coupon service provider and an approval to redeem the coupon is conveyed from the coupon service provider to the redemption device.

### BACKGROUND OF THE INVENTION

The present invention relates generally to wireless communication systems and, in particular, to a method and apparatus for transmission and redemption of coupons or discounts via wireless communication units in such systems.

Wireless communication systems are commonly known in the art. In particular, wireless communication units, e.g., handheld cell phones, two-way pagers, personal digital assistants (PDAs), portable net appliances, and other two-way wireless communication devices are increasingly becoming a part of everyday life. These devices facilitate the ability to remotely manage a significant amount of information. For example, currently available PDAs and cell phones allow a user to access voice mail messages and e-mail messages, or content on the Internet and World Wide Web.

While the use of such wireless communication units has greatly enhanced the individual's ability to manage information from a variety of sources, these technologies currently do not support, or provide only limited support for, repurposing data to a printed form. That is, a user who, for example, accesses his or her e-mail via the wireless communication unit has, until recently, experienced difficulty in printing any of the data they have accessed. Remote printing from a wireless communication unit has been disclosed in U.S. patent application No. 09/662,372, “Method and Apparatus for Printing via a Wireless Communication Device”, filed on behalf of Catherine C. Quinn on Sep. 13, 2000. Of course, if an individual carries a portable printer and has the ability to wirelessly download data to a device capable of communicating with the portable printer, then it may be possible to print such data. However, because most individuals choose not to stroll about with multiple devices in tow, this solution is largely impractical, especially when faced with the need for a hardcopy version of the accessed information.

It is common that advertisements such as banner ads and even promotional coupons and discount offers accompany (and subsidize) content desired by the individual. Restaurants, retail chains, and grocery stores are well known to offer discount coupons to individuals. However, individuals who receive a promotional coupon of a vendor or merchant via a wireless device and who do not have a printer accessible to them at the moment they want to redeem such a coupon are presently unable to redeem the coupon. This is because, prior to the present invention, coupons have typically been a printed certificate or ticket enticing the holder to a specified right to a reduced purchase price only upon presentment of the printed certificate or ticket for redemption.

It would be advantageous to individuals, merchants, Internet content providers, Internet service providers and the like to have the ability to receive, transmit and redeem coupons, as applicable, via wireless communications without requiring the printing of hardcopy coupons prior to presentation for redemption. In other words, it would be advantageous to provide a technique that allows a user to conveniently and remotely access and redeem coupons or discounts via a wireless device, without the need for multiple portable devices, such as a printer to immediately print out coupons or discounts.

### SUMMARY OF THE INVENTION

A method and apparatus for wireless coupon redemption includes a coupon service provider coupled to a wide area network and a wireless network to deliver an electronic coupon to a transportable communication unit. A merchant, comprising a wireless receiver coupled to a redemption device, is coupled to the coupon service provider such that a tender of said coupon by the transportable communication unit made via the wireless receiver is conveyed to the coupon service provider and an approval to redeem the coupon is conveyed from the coupon service provider to the redemption device.

### BRIEF DESCRIPTION OF THE DRAWINGS

FIG. 1 is a block diagram of a wireless communication system operating in conjunction with a coupon or discount delivery system in accordance with the present invention.

FIG. 2 is a block diagram of a wireless communication unit in accordance with the present invention.

FIG. 3 is a flowchart illustrating a method for coupon creation in accordance with the present invention.

FIGS. 4A and 4B, taken together, is flowchart illustrating a method of coupon redemption in accordance with the present invention.

### DETAILED DESCRIPTION OF A PREFERRED EMBODIMENT

The present invention facilitates the redemption of electronic coupons/discounts from a transportable communication unit, such as a PDA, a two-way pager, a cell phone, a portable net appliance, a suitably equipped personal computer, or a wireless handheld device by way of an authenticated transfer using electromagnetic radiation such as infrared (IR) or radio frequency (RF) wireless communication to a merchant's or vendor's coupon or discount redemption device. Such a merchant's coupon or discount redemption device includes a cash register or other like device that is adapted to receive and process coupon and discount information transmitted by a user's wireless communication device. In using the present invention, a user or consumer only needs to transmit from a wireless communication device the electronic coupon or discount to a merchant's coupon or discount redemption device in order to redeem the coupon or discount. The merchant's coupon or discount redemption device automatically credits the consumer's bill to reflect redemption of the coupon or discount. Thus, a consumer no longer needs to remember special coupon codes or print out a hardcopy of the coupon or discount offer in order to redeem the coupon or discount.

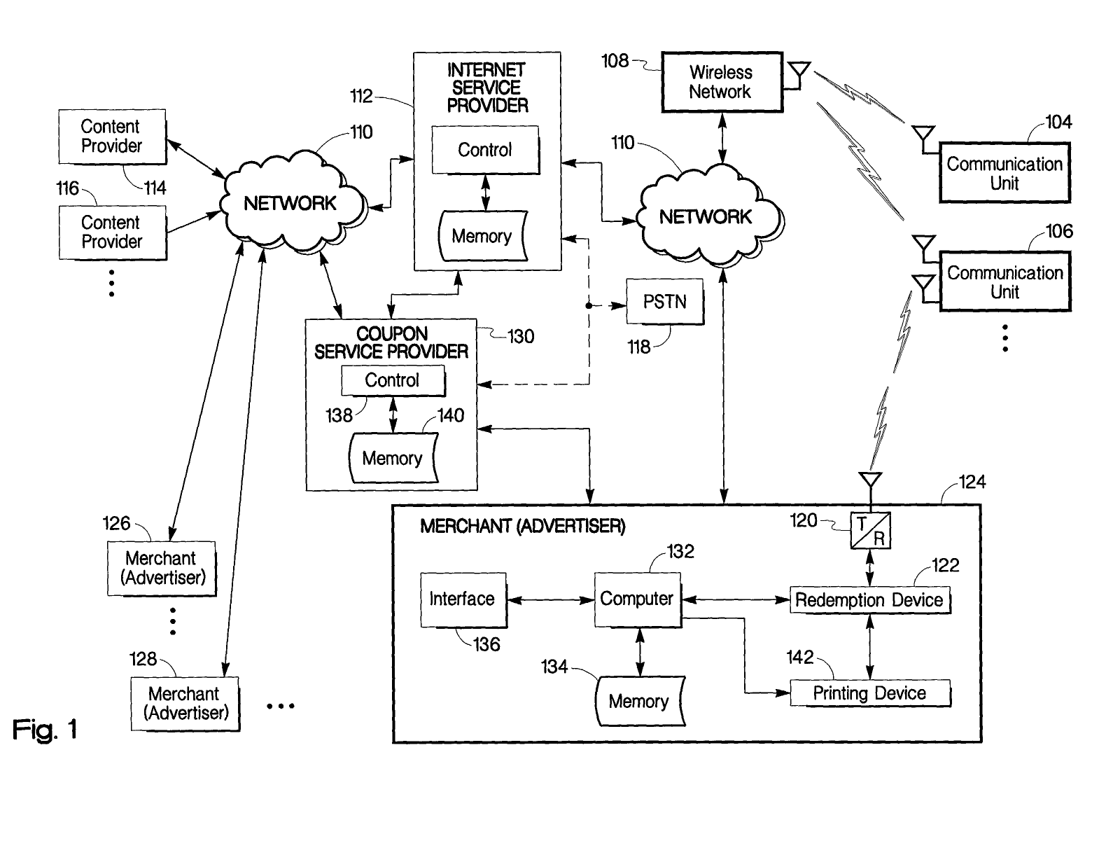

FIG. 1 illustrates a wireless communication system operating in conjunction with a coupon or discount delivery system. The wireless communication system comprises one or more communication units 104, 106 in communication with a wireless network 108 via a suitable wireless communication medium. The wireless communication units 104, 106 may comprise any device capable of two-way wireless communications and access to a source of content. Such access is typically realized through a wide area network such as the World Wide Web via the Internet (depicted as network 110) to an Internet service provider (ISP) 112, which in conventional fashion provides Internet services (e.g. e-mail) and connectivity (for content from a plurality of content providers 114, 116). Alternative arrangements between the ISP 112 and the wireless network 108, such as a connection between them using the public switched telephone network (PSTN) 118 (dial-up or dedicated line) or a captive wireless network within the service provider itself. In a preferred embodiment, the Wireless Application Protocol (WAP) standard is used for accessing content on the Internet and the wireless network 108 utilizes those conventional infrastructure elements needed to support such wireless communications.

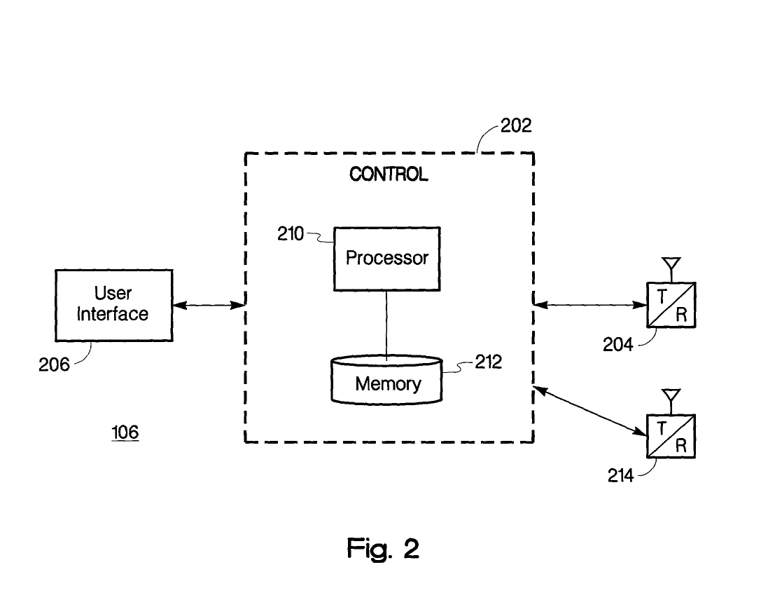

An exemplary wireless communication unit 106, in accordance with the present invention, is further illustrated in FIG. 2. In particular, the wireless communication unit 106 comprises a control function 202 coupled to a wireless transceiver 204 and a user interface 206. Preferably, the control function comprises a processor 210 (such as a microprocessor, microcontroller, digital signal processor and the like, or combination of such devices) operatively coupled to a memory 212 (such as volatile or non-volatile storage devices or combinations thereof, including, but not limited to random access memory, read-only memory and the like). Suitable software routines and processes used to control operation of the wireless communication unit 106 are stored in the memory 212 and executed by the processor 210. Furthermore, the control function 202 additionally comprises any interface circuitry or firmware needed to support the control options and to provide communications between the control function 202 and the transceiver 204 and the user interface 206. The transceiver 204 supports wireless communications and includes the capability to modulate and demodulate a wireless carrier, as known in the art. In the context of FIG. 1, the wireless transceiver 204 supports the electromagnetic communication link between the wireless communication unit 102 and the wireless network 108.

The user interface 206 comprises input and output devices that allow a user to operate the unit 106. Output devices include a speaker or annunciator for providing audible output and a display device for providing visual output. Input devices include a microphone for receiving audible input, including voice input, a keypad or keyboard or touch sensitive display device for providing input, and user-activated switches, buttons, or similar activators. In an advanced embodiment, the user interface 206 also comprises speech recognition functionality. Such functionality need not be confined to the user interface 206, and could be distributed between the user interface 206 and the control function 202, or implemented entirely by the control function 202. Additionally, the user interface may also comprise text-to-speech conversion functionality such that text-based information may be provided as audible output. Again, such functionality may be implemented in a centralized or distributed fashion as a matter of design choice.

The communication unit 106, in a preferred embodiment, communicates not only with the wireless network but also with a transceiver 120 coupled to a redemption device 122 associated with a merchant (advertiser) 124. Other merchants, for example merchants 126 and 128, may or may not provide the opportunity for the on-site redemption of coupons. Each merchant, however, as an advertiser providing advertising substance for the ISP 112, is coupled to the service provider 112 via the network 110, in the preferred embodiment. Such advertisers provide revenue to the service provider in return for the placement of advertising in conspicuous locations within content requested by the user. See, for example, U.S. patent application No. 09/738,199, “Method and Apparatus to Maximize Advertising Revenue”, filed on behalf of Daniel C. Castle et al. on Dec. 15, 2000. In a preferred embodiment, the ISP 112 is linked to the coupon or discount delivery provider 130 via a communications path that allows the transfer of traffic and control data between the ISP 112 and the coupon or service provider 130, either by a dedicated interconnection, as illustrated, or via the network 110 (connection not shown). Short-range wireless technology, offering reliable communications over a distance of meters or tens of meters, is preferred to couple the communications unit 106 to a register or redemption device 122. Because of the standardization, IEEE 802.11B (“Bluetooth”) RF transmission and reception is a preferred implementation of short-range technology, but the invention need not be so limited; infrared and other short-range electromagnetic coupling may alternatively be used. In any event, an electromagnetic transceiver 214 is disposed within the communication unit 106 to provide coupling between the processor 210 and other circuitry of the communication unit 106 and the transceiver 120 and redemption device 122 of the coupon-redeeming merchant 124. Of course, active repurposing of a single transceiver within the communications unit may be accomplished to reduce the size and power consumption of the communications unit.

Returning to FIG. 1, coupon information transmitted from the communication unit 106 via the short-range electromagnetic transmitter is received by the receiver of transceiver 120 of the merchant 124 and passed to the redemption device 122 and the computer 132 associated with the merchant 124. Relying upon an applications program and local information stored in memory 134, the merchant 124 contacts the coupon service provider 120 via interface circuitry 136 for instructions regarding the processing of a coupon electronically presented by the communications unit 106. Because of the diverse business arrangements possible between the parties, several different interconnection variations are possible between them. In a preferred embodiment, the merchant 124, the coupon service provider 130, and the ISP 112 are independent business entities using the Internet network 110 for interchange of information between them. Thus, the interface 136 of merchant 124 contacts the service provider 112 via the network 110 to subsequently access the coupon service provider 130 again via the network 110 in order to exchange information about the coupon-presenting activities of the communication unit 106. Alternatively, the merchant 124 may have a direct connection to the coupon service provider 130, a network 110 connection to the coupon service provider, or a PSTN connection to the coupon service provider.

In order to offer a coupon redemption service, the coupon service provider 130 comprises a controller 138 and associated memory 140 suitable for storing information on redeemable coupons or discounts for automatic delivery of this information to redemption device 122, which in a preferred embodiment is a point of sale register. The coupon service provider 130 receives coupon and discount offerings from one or more merchants or advertisers. Chains of merchants, for example retail merchant chains, are likely to have a centralized coupon/discount operation separate from each store and the distinction drawn in FIG. 1 between a coupon service provider and a plurality of merchants is blurred, as they may be more closely integrated and distribute functions differently than the illustration suggests. Decisions regarding which items are to be offered as a coupon-discounted item are made and stored at the centralized location, i.e., a single, captive, coupon service provider, and accessible only to associated merchants within the chain. Coupon-containing advertisements are provided to the service provider 112 for inclusion with user-desired content when a user's profile and advertiser target attributes match. (The user profile can be obtained by the ISP as part of the user's historical use of content providers' websites or by similar non-intrusive data gathering, or it can be directly provided by the user upon engagement of the ISP or coupon provider service). Again, a preferred embodiment is drawn to independent merchants working with a common, independent, coupon service provider; while recognizing that various business arrangements may be made that advantageously integrate the various operations of the present invention, such as the coupon service provider may be a subset of ISP functions.

Assuming the merchant (advertiser) 124 to be an independent merchant, the merchant 124 determines its advertisement and discount coupon parameters and delivers them to the coupon service provider 130. Included in this determination are the coupon parameters pertinent to the particular offering, for example, the date and time the advertisement coupon is to be delivered to a user or publicly made available; to what type of device the coupon should be directed; how frequently the coupon should be delivered—that is, some coupons are made available only for several hours, while others are made available for longer periods of time; whether the coupons are to be sent to one or more specific audiences (users of a particular credit card or frequent shoppers at the merchant); the value of the coupon and whether the value of the coupon is lower over some certain time period; and the expiration date and time of the coupon. The merchant is able to identify its target consumers for the coupon and that the coupon service provider is able to specify this in its advertising target profiles. The coupon service provider 130 retains the coupon parameters in memory 140 and, in the preferred embodiment, delivers advertisement form and substance including the appropriate coupon parameters and an encrypted authentication string, in addition to advertisement attributes describing the target consumer and time and place to the ISP 112 for inclusion with user-requested content.

When the coupon information has been presented to the merchant 124 by the communications unit 106 and the information is passed to the coupon service provider 130, the coupon service provider control 138 queries the memory about the coupon parameters and determines a match between the allowed parameters and the current conditions. Included with the coupon information is the encrypted authentication string that is decrypted and matched to prevent fraudulent digital discount coupons from being validated. A valid coupon causes the coupon service provider to return a validation to the merchant 124, authorizing the redemption of the coupon and a price adjustment to be made for the consumer presenting the coupon. The purchase receipt and an acknowledgement of the coupon use is printed on the printing device 142 of the merchant 124.

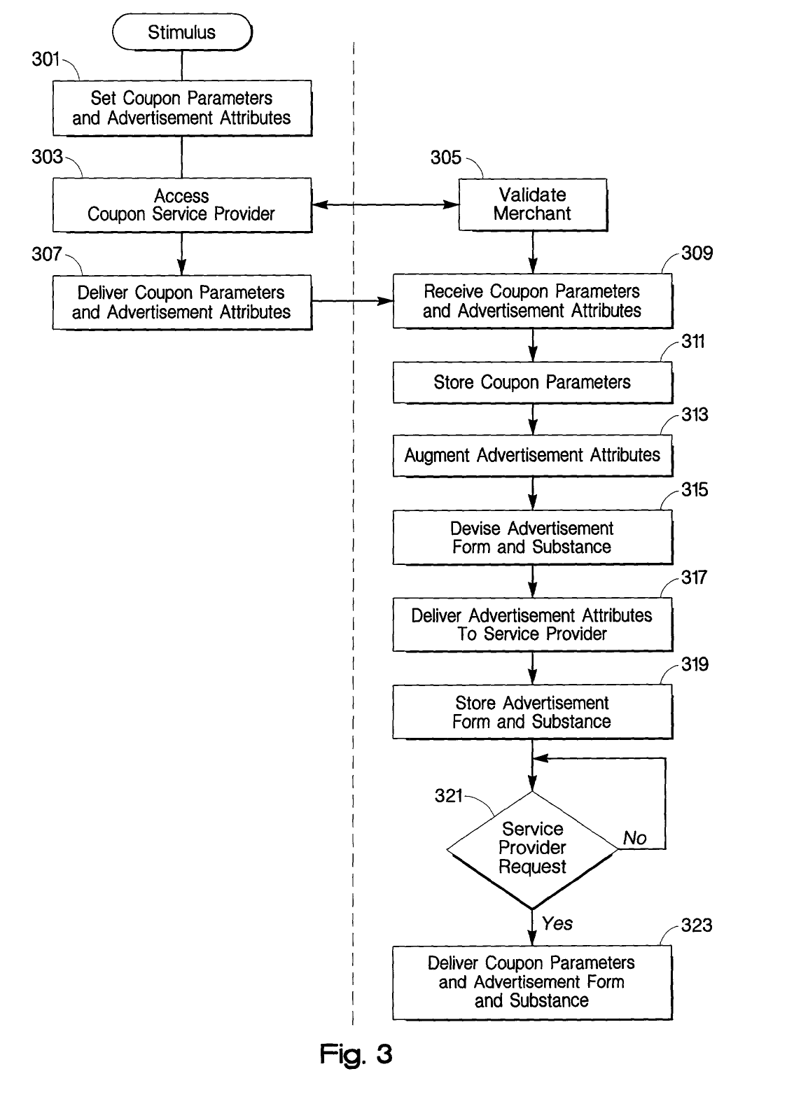

A process of creating a coupon is shown in the flowchart of FIG. 3. The process is divided according to a merchant entity and a coupon service provider entity with communication between the two depicted as horizontal links. As mentioned earlier, the function of providing the coupon service may be integrated with the merchant or the function may be integrated with the Internet service provider. However, in a preferred embodiment, the entities are independent. A merchant desires to offer a coupon discount on one or more items for sale to consumers in a preferred embodiment of the present invention. Since a preferred medium through which the merchant will deliver a coupon is that of publishing the coupon with an advertisement that is included with (and usually subsidizes) customer-desired content is an Internet delivery of content, the merchant utilizes an arrangement with a coupon service provider to produce and manage the advertisement and coupon activities. The merchant determines the need for the coupon discount and sets the coupon parameters and the advertisement attributes, at 301, accordingly. As previously mentioned these parameters can include the date and time of validity for the coupon, delivery instructions, coupon audience, the value of the coupon and whether the value varies with time, and the expiration of the coupon. Selection of these and other parameters are generally the prerogative of the merchant corresponding to the market impact desired. Similarly, the merchant can specify advertisement attributes such as the time and location the advertisements are to appear, the target audience for the advertisements, the type of content compatible with the advertisements, the type of communication unit to which the advertisements are to be directed, and so forth. The merchant then accesses, at 303, the coupon service provider 130, in a preferred embodiment, via the network 110 and awaits a validation of the merchant being an acceptable client of the coupon service provider. The coupon service provider validates the merchant, at 305, thereby triggering the merchant to deliver the coupon parameters and advertisement attributes, at 307, and the reception of the coupon parameters and advertisement attributes, at 309. The coupon parameters are stored, at 311. The advertisement attributes may be augmented by the coupon service provider, at 313, reflecting the coupon service provider's closer business relationship with the Internet service provider 112 to optimize the advertising expenditure, for example by resizing or reformatting the advertisement form and substance (including designing the discount coupon into the advertisement, if necessary), at 315, to fit the Internet service provider's content delivery template. The coupon service provider delivers the advertisement attributes to the Internet service provider, at 317, and stores the advertisement form and substance, at 319. The Internet service provider, in a preferred embodiment, does not itself store the advertisement and coupon but only the attributes with which it can match advertisement, user preferences, and content for a decision to include the advertisement with desired content. The coupon service provider waits, at 321, for a request by the Internet service provider for advertisement details, which it delivers inclusive of the coupon parameters, at 323.

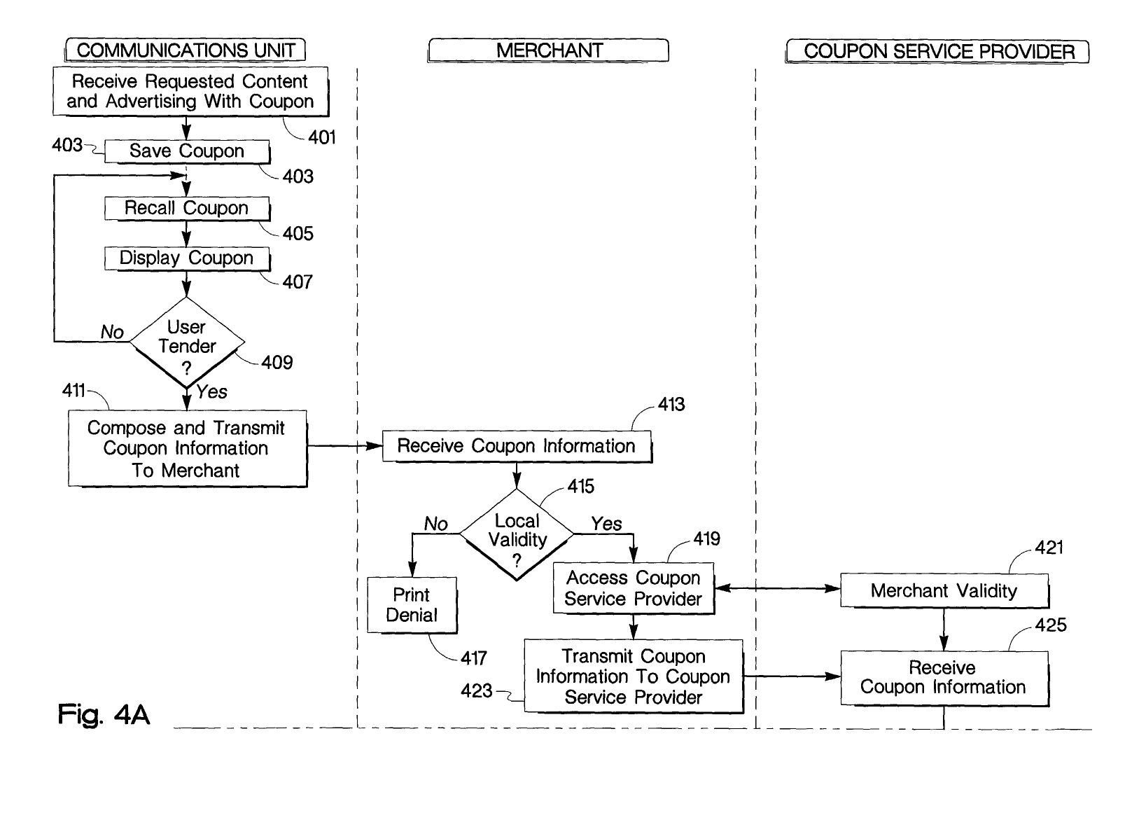

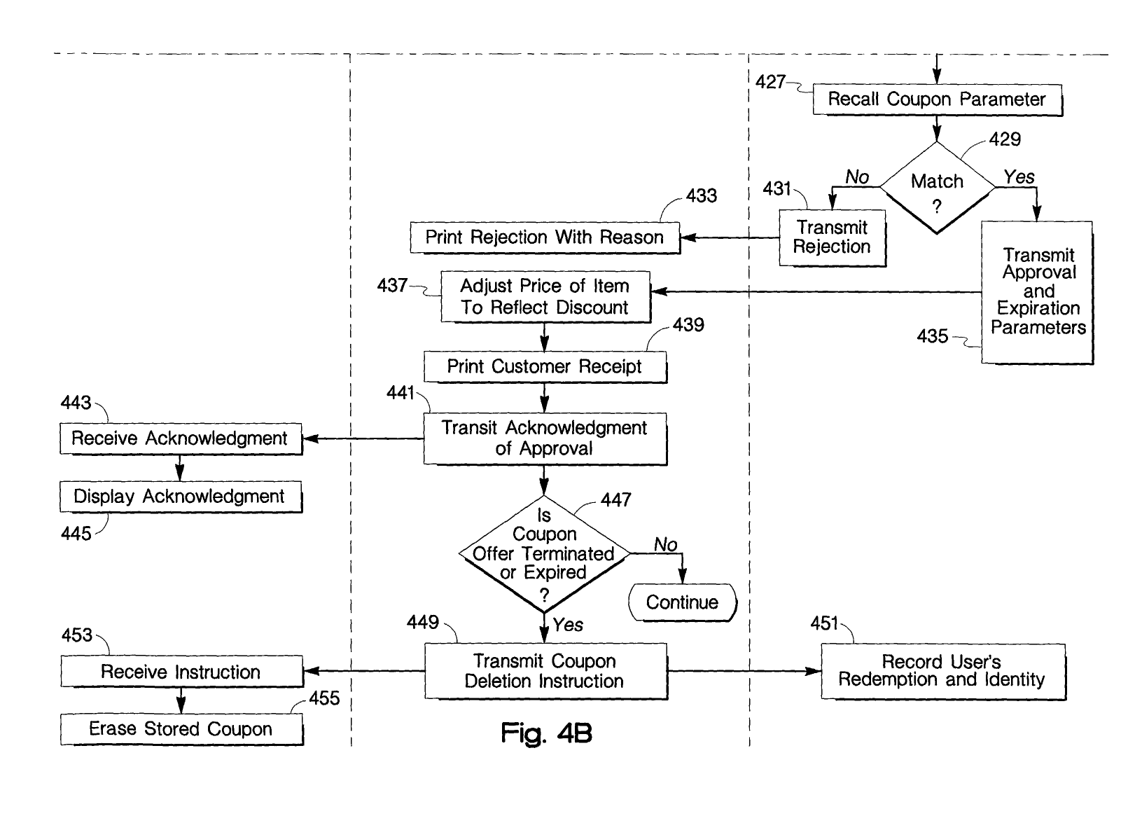

The communications unit 106 receives content from the Internet service provider 112 upon request. Such content can be a search engine's search results or a merchant's web page or countless other informational documents conventionally available. Accompanying such content is a subsidizing advertisement and in accordance with the present invention a digital coupon or discount certificate, at 401. A process of coupon redemption is shown in the flowchart of FIGS. 4A and 4B, in which the actions and responses of the communications unit, the merchant, and the coupon service provider are illustrated. The digital coupon is saved, at 403, for later use by the user of the communications unit. When the user desires to redeem the coupon, the user, by way of the communication unit interfaces, causes the communications unit to recall the coupon, at 405, and display the coupon details on the communications unit's display, at 407. Upon viewing the coupon, the user can determine whether the coupon is valid for the contemplated purchase, at 409, and if the user believes it to be so, the user causes the communications unit to transmit the coupon details to the merchant's redemption device, via the short-range electromagnetic transmitter, at 411. In a preferred embodiment, the coupon parameters include details about presentation of the coupon on a human-perceptible display and acoustic reproducer as well as details regarding local validity to the merchant and validity to the coupon service provider. A portion of the coupon parameters are returned by the communication unit when the coupon is tendered for redemption. The merchant receives the coupon information, at 413, and determines the validity of the coupon, at 415, based upon local parameters such as the store identity. (A coupon issued by and valid only at Store A will not be accepted at Store B, for example). If the coupon is not accepted, the merchant prints a denial explanation, at 417, for physical presentation to the user. If the coupon appears to have local validity, the coupon service provider is accessed, at 419, and a determination of the merchant's validity is exchanged, at 421. If the merchant is a valid client of the coupon service provider, the coupon information is transmitted to the coupon service provider, at 423, and the coupon service provider receives the coupon information from the validated merchant, at 425. The coupon service provider recalls the coupon parameters from memory storage, at 427, and tests, at 429, each parameter submitted with the transmitted coupon information with respective stored parameters of the coupon parameters. Included among the transmitted and tested parameters is an encrypted security sequence to avoid fraud. If a mismatch of coupon information and respective coupon parameters occurs, the coupon is deemed invalid and a message, including the mismatch reason, is transmitted to the merchant, at 431. The merchant prints a hardcopy of the reason for rejection, at 433, and may take other actions as needed. If a match for all significant parameters occurs, an approval of the coupon and expiration/termination parameters are transmitted to the merchant, at 435. With the approval, the merchant adjusts the price of the item to reflect the discount, at 437, proceeds with the remainder of the transaction, and prints a customer receipt with the coupon value indicated, at 439. An acknowledegement of coupon approval is transmitted by the short-range transceiver 120, at 441, and received by the communication unit, at 443. The communication unit responsively displays the acknowledgement, at 445, to provide feedback to the coupon-redeeming customer. If the coupon parameters indicate an expiration or termination of the coupon offer following the current redemption (for example, a single-use coupon or quantity limit), the merchant's redemption device transmits a coupon deletion message to the communications unit and causes a message to be sent to the coupon service provider as part of the acknowledgement and coupon deletion message sent to the user, at 449. The coupon service provider records the user's redemption of the coupon and an identification of the user, at 451, and stores this information for later use if another redemption of the same coupon is tried. The communications unit receives the short-range electromagnetic transmission of the coupon deletion instruction, at 453, and erases the stored coupon, at 455. In an alternative embodiment, coupon expiration due to time results in an automatic deletion from the storage of a communication unit having a tamper-resistant internal calendar.

In another alternative embodiment, the merchant employs a self-contained coupon service provider and transmits a local coupon to the communications unit of the user via the merchant's short-range electromagnetic radiation transmitter as the user enters the store. Such instant coupons are stored and recalled by the communications unit as described above and the redemption occurs via the short-range electromagnetic radiation as previously described.

An understanding of the use of the present invention may be enhanced by considering several less apparent examples. First, a user has dinner in a merchant restaurant (a merchant). Before receiving the bill, the user can use his or her communications unit 106 to check with the redemption device 122 of the restaurant to determine whether the restaurant is offering any local coupons or discount certificates. If the communications device receives back from redemption device that an applicable coupon or discount is being offered, the user can then request delivery of that coupon and at the appropriate time, request redemption of that coupon. The redemption device locally processes the redemption request, confirms to the user's communication unit that the coupon or discount is being honored and shown on the user's bill, and instructs the printing device 142 to reflect the redeemed coupon or discount on the user's bill. All of the communication between the user's communication device and the merchant's redemption device 114 is performed locally by short-range wireless communication and local merchant computer processing.

In another example, a user is shopping at a department store and is interested in purchasing an item, for example a name-brand shirt. He or she can then use his or her communications unit to access an Internet service provider 112 to obtain content indicating whether any merchant with a presence on the Internet, which may include the department store or its chain, is offering the shirt and whether a discount or coupon is applicable. If a coupon is available and delivered, the user is able to send a discount request to the merchant department store's redemption device to request that a discounted price be applied to the item given that the item is purchased at the present department store. The redemption device (or a sales person) can advise the user whether a discounted price will be applied. If a discount price will be applied, a discount certificate (typically limited to the terms of the immediately preceding exchange) is transmitted by the present merchant department store to the communications unit as described previously. When the user purchases the item, the discounted price appears on the user's receipt for the item and the immediate discount certificate is deleted from the communications unit's memory.

In another use of the present invention, a user searches a coupon service provider's web page via the Internet from a home computer and downloads coupons directly from the coupon service provider, rather than wait for coupons to be serendipitously delivered with desired content. The coupons can be selected, organized, or archived in the user's home computer. The user's home computer is then used to forward into the communications device selected coupons for various items of various food manufacturers that the user will be purchasing from a grocery store at some later time, e.g., the next day. At the grocery store check-out line, the user, with the press of a button, redeems all of the selected coupons by sending a coupon redemption request for each item simultaneously to the merchant grocery store's redemption device 122. The purchase receipt to the user identifies all of the redeemed coupons and the savings to the user. Thus, a user no longer needs to search newspapers for printed coupons, clip the printed coupons, save the printed coupons, bring the printed coupons to the grocery store, present the printed coupons by hand to the grocery store cashier, and wait for the grocery store cashier to ring up each individual, printed coupon to redeem each coupon.

An advanced version of the coupon service provider offers a user a personal coupon account service bearing a subscription fee. The coupon service provider organizes and posts for downloading to the communications unit the coupons of various participating merchants. A subscribing user is able to access the coupon service provider via the Internet and download the coupons to the communications unit. The user can select, organize, and archive the coupons within the communications unit for presentation to a merchant. Alternatively the user can, via the communications unit, request coupon redemption for any item having a coupon stored in the communications unit and scanned by the merchant's redemption device as part of the user's check-out from the merchant store. The redemption device automatically redeems any applicable coupons.

If the coupon service provider coupon clipping service is offered without fee, the merchants subsidize the operation by obtaining coupon use data for advertisement optimization. A merchant may want to identify when and where the coupons are being realized, as well as by whom. Each digital coupon is encoded with a unique identification number (in addition or in combination with to the encrypted fraud-prevention sequence) that archives at least: who used the coupon; the geographic location of where the coupon was used; what type of advertising content the user may be interested in having delivered for future use; and the name of the merchant who redeemed the coupon's value.

Thus, a technique for redeeming coupons via a wireless communication unit has been shown and described. Discount coupons and certificates are transmitted to the communications unit for the user to use in purchasing items or services. Transmitting stored coupon information from a user's wireless communications unit to a redemption device of a merchant accomplishes the redemption.

We claim:

1. A coupon delivery and wireless redemption system comprising:
a coupon service provider coupled to a wide area network;
a wireless network coupled to said wide area network;
a merchant coupled to said coupon service provider and comprising a wireless receiver coupled to a redemption device;
wherein an electronic coupon is delivered to a transportable communication unit from said coupon service provider via said wide area network and said wireless network, a tender of said coupon by said transportable communication unit made via said wireless receiver is conveyed to said coupon service provider, and an approval to redeem said coupon is conveyed from said coupon service provider to said redemption device.

2. A coupon delivery and wireless redemption system in accordance with claim 1 wherein said wireless receiver further comprises a short range wireless transceiver that receives a signal from a transportable communication unit representing coupon information presented for redemption and wherein said merchant comprises:
an interface coupled to said wide area network for communication with said coupon service provider;
a computer and associated memory coupled to said short range wireless transceiver and said interface to accept said signal from said short range wireless transceiver, to convey coupon information to said coupon service provider via said interface, and to accept a coupon approval from said coupon service provider via said interface; and
said redemption device, being coupled to said computer such that a price for an item is calculated when said coupon is approved.

3. A coupon delivery and wireless redemption system in accordance with claim 1 wherein said transportable communication unit comprises:
a first transceiver adapted to communicate with said wireless network coupled to a wide area network to receive delivery of said electronic coupon;
a processor and associated memory that stores said received electronic coupon;
a user interface that provides a human perceptible indication of said stored electronic coupon and that accepts a user activation to tender said stored electronic coupon for redemption; and
a second transceiver adapted to communicate said tender to said coupon redemption device.

4. A wireless coupon redemption system, comprising:
an interface coupled to a network for transmission of a coupon to a transportable communication unit;
a short-range wireless transceiver that receives a signal from said transportable communication unit, said signal representing coupon information tendered for redemption;
a computer and associated memory coupled to said interface and said transceiver and adapted to generate said coupon for said transportable communication unit and to approve valid tendered coupon information; and
a redemption device, coupled to said computer and associated memory, adapted to calculate a price for an item upon approval of valid tendered coupon information.

5. A wireless coupon redemption system in accordance with claim 4 wherein said network is coupled to a wireless network and wherein said transportable communication unit comprises:
a first transceiver adapted to communicate with said wireless network coupled to receive said coupon;
a processor and associated memory that stores said received coupon;
a user interface that provides a human perceptible indication of said stored coupon and that accepts a user activation to tender said stored coupon for redemption; and
a second transceiver adapted to transmit said signal to said short range wireless transceiver.

6. A transportable communication unit for use in a wireless coupon redemption system, comprising:
a first transceiver adapted to communicate with a wireless network coupled to a wide area network to receive an electronic coupon;
a processor and associated memory that stores said received electronic coupon;
a user interface that provides a human perceptible indication of said stored electronic coupon and that accepts a user activation to tender said stored electronic coupon for redemption; and
a second transceiver adapted to communicate said tender to a coupon redemption device.

7. A method of providing a coupon to a user for wireless redemption, comprising the steps of:
receiving and storing coupon parameters;
receiving a request to deliver said stored coupon parameters;
delivering said coupon parameters to a wireless network;
receiving at least a portion of said coupon parameters as coupon information tendered by a user as a request for redemption;
comparing said coupon information to said stored coupon parameters; and
approving said redemption request, responsive to said comparing step, when said coupon information matches a respective portion of said stored coupon parameters.

8. A method in accordance with the method of claim 7 further comprising the steps of:
receiving advertisement attributes;
storing advertisement form and substance in an associative context related to said advertisement attributes; and
delivering said advertisement form and substance with said coupon parameters.

9. A method in accordance with the method of claim 7 further comprising the steps of:
receiving an indication of a successful fulfillment of said request for redemption; and
recording said successful fulfillment and an identity of said user.

10. A method in accordance with the method of claim 7 wherein said coupon provider service includes the service of a merchant, further comprising the steps of:
receiving a wireless request for redemption by said user;
adjusting a price in response to said approving step; and
transmitting an acknowledgement of approval to said user.

11. A method in accordance with the method of claim 10 wherein said transmitting step further comprising the step of transmitting a deletion instruction for said coupon information.

12. A method in accordance with the method of claim 10 further comprising the step of printing a customer receipt including said adjusted price.

13. A method of establishing and redeeming coupons, comprising the steps of:
conveying coupon parameters for use in providing a coupon to a user;
receiving a request for coupon redemption, said request including at least a portion of said coupon parameters as coupon information;
obtaining an approval of said request for coupon redemption based upon a match of said coupon information and a respective portion of said coupon parameters; and
adjusting a price in response to said approval obtained in said obtaining step.

14. A method in accordance with the method of claim 13 further comprising the step of printing a receipt for the user in response to said obtained approval, said receipt including said adjusted price.

15. A method in accordance with the method of claim 13 further comprising the step of transmitting an acknowledgement of redemption approval to said user in response to said obtained approval.

16. A method in accordance with the method of claim 15 wherein said step of transmitting an acknowledgement further comprises the step of transmitting a deletion instruction for said user's coupon.

17. A method in accordance with the method of claim 13 further comprising the step of comparing a second portion of said coupon information to local validity information.

18. A method in accordance with the method of claim 13 further comprising the steps of:
storing said coupon parameters;
receiving a request to deliver said coupon parameters;
comparing said coupon information to said at least a portion of said coupon parameters; and
providing said approval of said request for coupon redemption in response to a match in said comparing step.

19. A method in accordance with the method of claim 13 further comprising the step of recording a successful fulfillment of said request for coupon redemption and an identity of said user.

20. A method of electronically obtaining and redeeming coupons in a transportable communication unit, comprising the steps of:
receiving content and a content-subsidizing advertisement from a wide area network, said content-subsidizing advertisement including an electronic coupon;
storing said electronic coupon;
providing a human perceptible reproduction of said stored electronic coupon;
accepting a user's input to tender said electronic coupon for redemption; and
transmitting said electronic coupon to a merchant's redemption device in response to said accepting step.

21. A method in accordance with the method of claim 20 further comprising the step of receiving an acknowledgement transmission from said merchant's redemption device.

22. A method in accordance with the method of claim 21 wherein said receiving step further comprises the step of receiving an electronic coupon deletion instruction from said merchant's redemption device.

23. A method in accordance with the method of claim 22 further comprising the step of deleting said electronic coupon from storage in response to said receiving said electronic coupon deletion message.
